(19) United States
(12) Patent Application Publication
(10) Pub. No.: US 2004/0266396 A1
(43) Pub. Date: Dec. 30, 2004

(54) Digital transmitter displays

(76) Inventors: Steven G. Henry, Fort Collins, CO (US); Charles Allen Untulis, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/603,726

(22) Filed: Jun. 25, 2003

(51) Int. Cl. H04M 3/00

(52) U.S. Cl. 455/412.1; 455/418

(57) ABSTRACT

A display for a digital transmitter has a graphical map with a plurality of interconnected icons. A size of each of the icons varies according to the distance of the respective icon from a central region of the display.

### FIELD OF THE INVENTION

The present invention relates generally to graphical displays

### BACKGROUND

Digital transmitters, such as digital senders, digital network copiers, multi-function peripherals, etc., convert printed material, e.g., paper documents, into digital data to be sent to various predefined destinations, e.g., electronic mail (email) addresses, facsimile (fax) destinations (e.g., via LAN fax, Internet fax, etc.), network printers, personal computers, network storage devices, or other data receiving devices. Digital transmitters normally include a scanner for scanning the printed material for subsequent conversion into digital data by the digital transmitter. For many applications, digital transmitters convert the data into a data file, e.g., formatted data files, such as Portable Document Format (PDF), Tag Image File Format (TIFF), Joint Photographic Experts Group (JPEG), or other data format.

The data files are often located in a file system, a folder system, a file/folder system, or the like of a database, such as a document management system, a workflow system, etc., in a memory of the digital transmitter or on a network storage device. The elements of the database, e.g., files and/or folders, are usually represented by names listed on a series of drop-down lists on a display of the digital transmitter, e.g., according to a hierarchy. Navigating drop-down lists can become difficult and often confusing, for example, for a large number of database elements, a large number of hierarchical levels, etc. Moreover, many digital scanners have relatively small displays that can make navigating drop-down lists difficult, especially drop-down lists having a large number of database elements, hierarchical levels, etc.

### SUMMARY

An embodiment of the present invention provides a display for a digital transmitter having a graphical map with a plurality of interconnected icons. A size of each of the icons varies according to the distance of the respective icon from a central region of the display.

### DESCRIPTION OF THE DRAWINGS

FIG. 1 is a block diagram of a digital transmitter according to an embodiment of the present invention.

FIG. 2 illustrates a user interface of the digital transmitter of FIG. 1.

FIG. 3 illustrates a display of the user interface of FIG. 2 according to another embodiment of the present invention.

FIG. 4 illustrates a display of the user interface of FIG. 2 according to another embodiment of the present invention.

FIG. 5 illustrates a display of the user interface of FIG. 2 according to another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

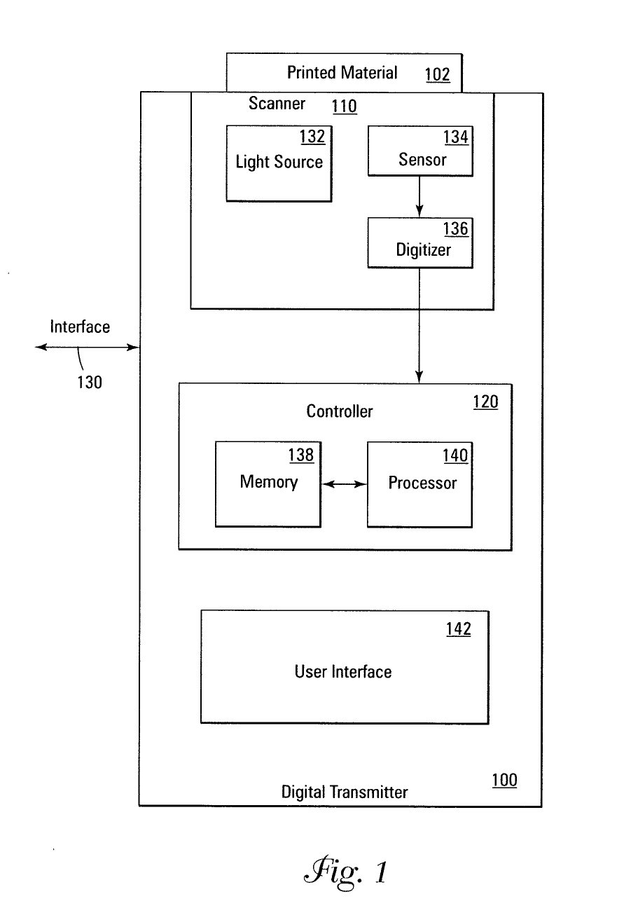

FIG. 1 is a block diagram of a digital transmitter 100, such as a digital sender, digital network copier, multi-function peripheral, etc., according to an embodiment of the present invention. Digital transmitter 100 includes a scanner 110 connected to a controller 120. Scanner 110 converts printed material 102, e.g., printed documents, into digital data that are sent to controller 120. For one embodiment, controller 120 is adapted to format the data received from scanner 110 into a bitmap format. For other embodiments, controller 120 converts the data into a formatted data file, such as Portable Document Format (PDF), Tag Image File Format (TIFF), Joint Photographic Experts Group (JPEG), or other data format, for example, from the bitmap format. Controller 120 is adapted to transmit digital data, e.g., corresponding to the formatted data file, a bitmap, etc., via an interface 130 to one or more destination addresses on a data network. For one embodiment, the destination addresses are network addresses of network devices (printers, servers, workstations, storage devices, etc.), electronic messaging addresses (e.g., email), facsimile (fax) numbers, etc., and the data network is a Local Area Network, the Internet, or the like. For another embodiment, interface 130 is a network adaptor (or network interface card).

More specifically, for one embodiment, scanner 110 includes a light source 132 and a sensor 134, such as a charged-coupled device (CCD), connected to a digitizer 136, e.g., an analog-to-digital converter. Light source 132 illuminates printed material 102. The light is reflected off of printed material 102 and is received at sensor 134 that converts the reflected light into an analog electrical signal representative of printed material 102. The electronic signal is transmitted to digitizer 136 that converts the analog electrical signal into a digital electrical signal. The digital electrical signal is then transmitted to controller 120.

For one embodiment, controller 110 includes a memory 138, e.g., a computer-usable storage media that can be fixedly or removably attached to digital transmitter 100. Some examples of computer-usable media include static or dynamic random access memory (SRAM or DRAM), read-only memory (ROM), electrically-erasable programmable ROM (EEPROM or flash memory), magnetic media and optical media, whether permanent or removable. Memory 138 may include more than one type of computer-usable media for storage of differing information types.

In various embodiments, memory 138 stores data of the digital signal received from digitizer 136 for subsequent formatting by controller 120. In one embodiment, memory 138 stores the data prior to transmission of the data to the one or more destination addresses on the data network. For another embodiment, memory 138 contains computer-readable instructions, e.g., drivers, adapted to cause a processor 140 of controller 120 to format the data received from scanner 110 and computer-readable instructions to cause processor 140 to cause digital transmitter 100 to perform various methods, as described below.

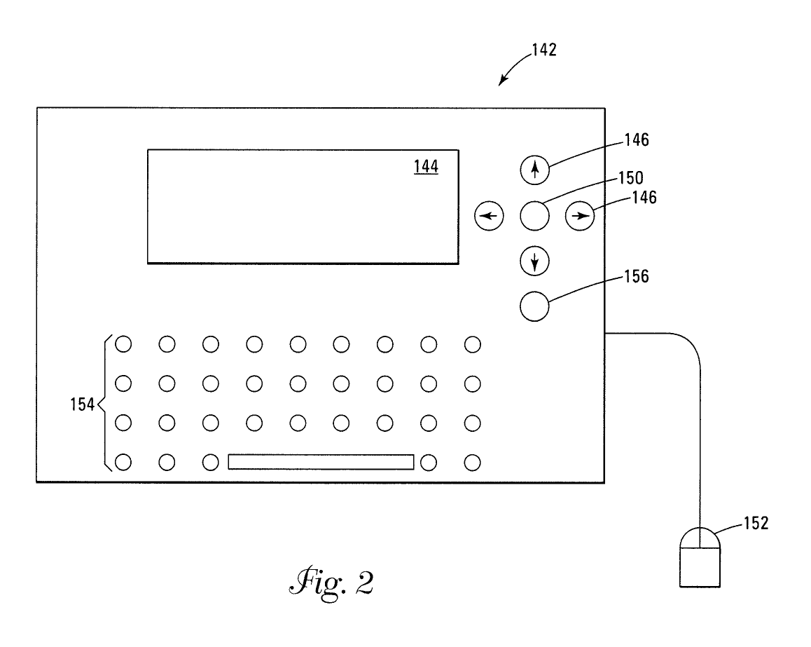

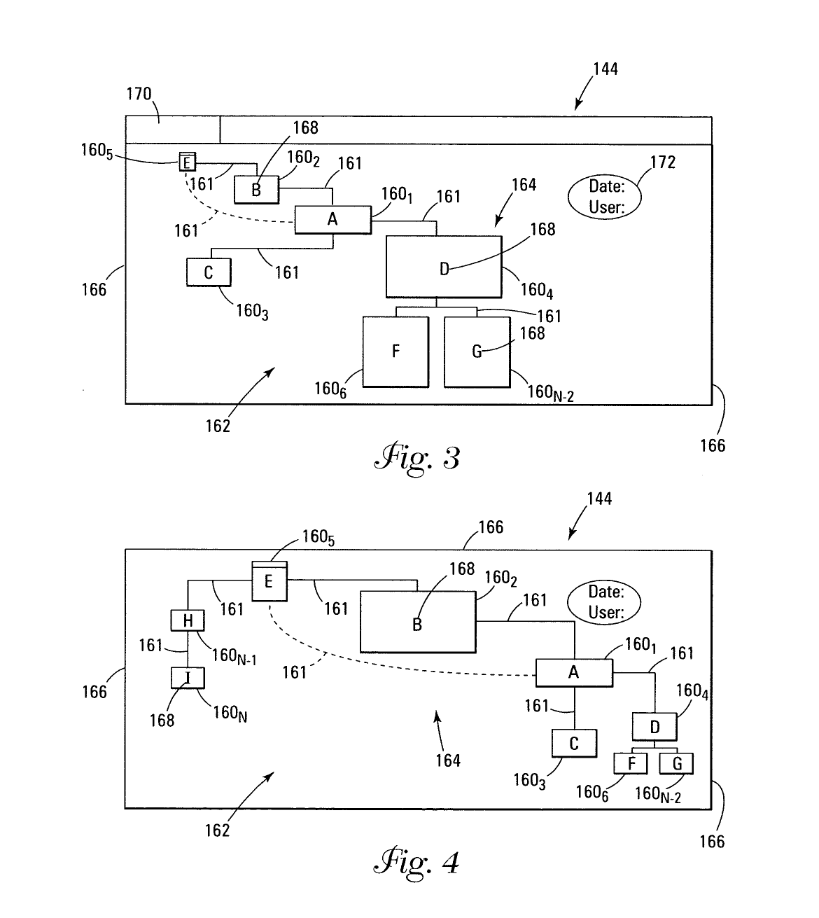

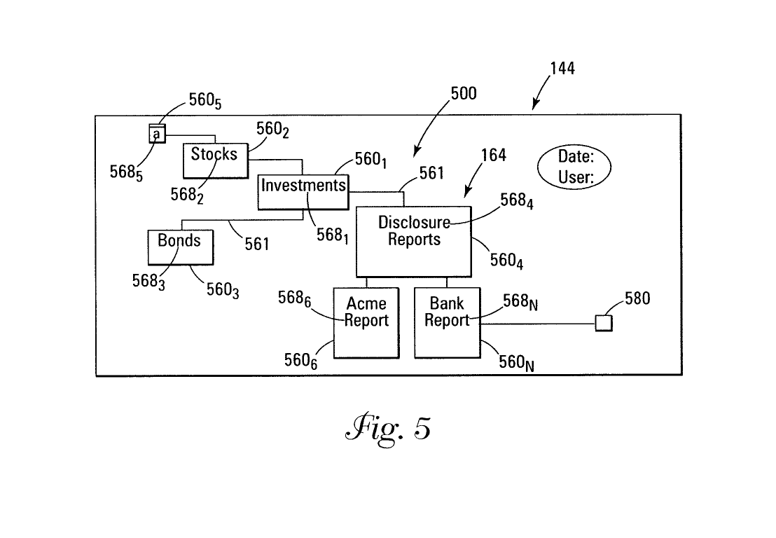

For one embodiment, digital transmitter 100 includes a user interface 142, as illustrated in FIG. 2. User interface 142 includes a display 144 having icons 160, as illustrated in FIGS. 3 and 4. For some embodiments, user interface 142 includes directional keys 146 for navigating display 144, e.g., for highlighting one or more of icons 160, and a select button 150 for selecting the highlighted icons 160. For other embodiments, user interface 142 includes a pointing device (or mouse) 152 for selecting one or more of icons 160. For one embodiment, display 144 and thus icons 160 are touch-sensitive. For another embodiment, display 144 is grayscale or color. User interface can also include a keyboard 154, such as an alphanumeric keyboard and a scan button 156 for causing digital transmitter 100 to scan printed material 102.

For various embodiments, icons 160 represent menu items, folders and/or files of a database (e.g., a document management system, a workflow system, etc.) stored in memory 138 or on a network storage device, destination addresses stored in memory 138, or the like. For one embodiment, one or more of icons 160 are functional icons for causing digital transmitter 100 to perform tasks when selected, such as scanning printed material 102, sending data corresponding to printed material 102 to memory 138, to a network storage device, and/or to the destination devices, etc. For another embodiment, selecting one of icons 160 can cause controller 120 to create a formatted data file, as described above. For yet another embodiment, selecting one of icons 160 can cause controller 120 to process the data corresponding to printed material 102, e.g., using Optical Character Recognition (OCR) routines on text elements and/or running various forms of image enhancement algorithms on image elements, such as red-eye removal, contrast adjustment, sharpness, smoothing, or other filters or modifications.

For some embodiments, icons 160 are interconnected by lines 161, e.g., that can be solid, dashed, curved, colored, or combinations thereof, to form a graphical map 162 of the database, menu, destination addresses, etc., as shown in FIGS. 3 and 4. Icon 160₁ is connected to icons 160₂, 160₃, and 160₄. Icon 160₂ is connected to icon 160₅, and icon 160₄ is connected to icons 160₆ and 16o_{N-2}. The computer-readable instructions cause controller 120 to cause display 144 to vary the size of icons 160 according to their distance from a central region 164 of display 144, with the size of icons 160 decreasing from their largest size at central region 164 to their smallest size near edges 166 of display 144, as shown in FIGS. 3 and 4. For one embodiment, the enlarged icons in the central region correspond to a current location within map 162.

Moving through map 162, e.g., using directional keys 146, pointer 152, gestures, touching one or more of icons 160, etc., causes icons 160 at the current map location to enlarge and display in central region 164 and icons located at various distances from the current map location to diminish in size according to their distance from the current location and to display at a distance from edges 166 according to their distance from the current location. For example, moving from a first (or the current) map location in FIG. 3 corresponding to icons 160₄, 160₆, and 160_{N-2} to a second map location in FIG. 3 corresponding to icon 160₂ causes icon 160₂ to enlarge and display in central region 164 and icons 160₄, 160₆, and 160_{N-2} to diminish in size and to display adjacent one of edges 166, as illustrated in FIG. 4.

Moving from the first to the second map locations causes icon 160₅, located at a third location in FIG. 3, to enlarge and move toward central region 164 in FIG. 4. This is because icon 160₅ is closer to the current location in FIG. 4 than in FIG. 3. Moving from the first to the second map locations also causes icon 160_{N-1}, connected to icon 160₅, and icon 160_{N}, connected to icon 160_{N-1}, to display, as shown in FIG. 4. In FIG. 3 icons 160_{N-1} and 160_{N} are at rather a large distance from the current map location (corresponding to icons 160₄, 160₆, and 160_{N-2}) and thus their proximity to edge 166 causes them to be too small to be observed in FIG. 3. However, in FIG. 4, icons 160_{N-1} and 160_{N} are closer to the current map location (corresponding to icon 160₂) and thus are located closer to central region 164, causing icons 160_{N-1} and 160_{N} to be larger and thus to be more easily viewed.

For one embodiment, each of icons 160 includes an identifier 168 for identifying contents of a folder or file associated with the respective one of icons 160, a particular function (or task) performed when selecting the respective one of icons 160, name of a recipient located at one of the destination address, etc. For the illustrative purposes the identifiers 168 for icons 160₁ to 160_{N} are respectively letters A-I. Note that identifiers 168 change in size as the corresponding icons 160 change in size.

For one embodiment, graphical map 162 is a hierarchical map and icons 160 correspond to different levels of the hierarchy. For example, icon 160₁ may correspond to a first level of the hierarchy, icons 160₂, 160₃, and 160₄ to a second level, icons 160₅, 160₆ and 160_{N-2} a third level, icon 160_{N-1} a fourth level, and icon 160_{N} a fifth level. For another embodiment, graphical map 162 is a hierarchical menu of user interface 142 and icons 160 are menu items located at different hierarchical levels. In this embodiment, icons 160 are the functional icons described above.

For some embodiments, disconnecting an icon 160 from one part of map 162 and connecting the icon 160 to another part of map 162 can modify map 162. For example, icon 160₆ can be disconnected from icon 160₄ and connected directly to icon 160₅. Selecting icon 160₆ using pointing device 152 and dragging icon 160₆ onto icon 160₅ can accomplish this. For embodiments having touch-sensitive icons 160, a user can select icon 160₆ and drag icon 160₆ onto icon 160₅ using a finger. For one embodiment, dragging icon 160₆ onto icon 160₅ causes icon 160₆ to display adjacent to icon 160₅ and to be connected to icon 160₆ by a line 161. For other embodiments, icon 160₆ is dragged to the desired location adjacent icon 160₅, and the line 161 is drawn between icons 160₅ and 160₆ by selecting a drawing option, e.g., from a pull-down menu 170 of display 144, and using pointing device 152 or the user's finger. The size of icon 160₆ will be adjusted according to the new distance between icon 160₆ and central region 164.

Adding icons 160 to map 162, e.g., by selecting a new-icon option from pull-down menu 170, can also modify map 162. For some embodiments, selecting the new-icon option causes display 144 to prompt the user to select an icon type, e.g., an icon corresponding to a folder, a file, a destination address, a step in a process, etc. For one embodiment, selecting an icon type causes display 144 to display that icon type. Selecting an icon type may cause display 144 to prompt the user to input identifier 168, e.g., using keyboard 154. For another embodiment, the user may be prompted to input additional icon information that is not displayed on the icon, for example, the input identifier 168 may be a name of a recipient of data corresponding to printed material 102, and the additional icon information may be a destination address of the recipient. After supplying the information, the new icon can be connected to any portion of map 162, as described above. Alternatively, the user can be prompted to input the identifier 168 of the icon 160, such as icon 160₅, to which the new icon 160 will be connected, e.g., either before or after the user inputs identifier 168 and any additional icon information, and display 144 displays the new icon 160 and connects the new icon 160 to icon 160₅ without further user intervention.

A new map 162 can be generated, e.g., by selecting a new-map option from pull-down menu 170. For some embodiments, selecting the new-map option causes display 144 to prompt the user to input a map title and, for example, a storage location for the elements represented by the map icons, such as memory 138 or a network storage device. For one embodiment, the user can construct the map by adding icons to the new map 162 as described above, i.e., using the new-icon option and connecting the newly created icons at various locations within the map.

For another embodiment, display 144 includes an indicator 172 for displaying historical information about map 162, for example, the date map 162 was last displayed and/or a user identifier for identifying the user who last displayed map 162.

FIG. 5 illustrates a map 500 of a database stored on memory 138 or on a network storage device according to another embodiment of the present invention. Map 500 includes icons 560₁ to 560_{N} interconnected by lines 561 and respectively having identifiers 568₁ to 568_{N} (e.g., folder or file titles), as shown in FIG. 5. Icon 560₁ represents a folder, e.g., entitled Investments (identifier 568₁). Icon 560₁ is connected to icons 560₂ to 560₄ respectively representing folders, e.g., entitled Stocks, Bonds, and Disclosure reports (respectively identifiers 568₂-568₄), contained within Investments. Icon 560₂ is connected to icon 560₅ that represents a digital data file stored in Stocks and corresponding to a printed document, e.g., a stock certificate entitled a (identifier 568₅), scanned into digital transmitter 100.

Icon 560₄ is connected to icon 560₆, representing a data file stored in Disclosure reports and corresponding to a printed document, e.g., a report entitled Acme Report (identifier 568₆), scanned into digital transmitter 100. Icon 560₄ is also connected to icon 560_{N}, representing a digital data file stored in Disclosure reports and corresponding to a printed document, e.g., a report entitled Bank Report (identifier 568_{N}), scanned into digital transmitter 100. For another embodiment icons 560₆ and 560_{N} are miniature representations, e.g., thumbnails, of the reports represented thereby.

For one embodiment, a new file is added to map 500 by selecting a new-file icon from pull-down menu 170, shown in FIG. 3. The user is prompted to select a scan icon from pull-down menu 170 or to press scan button 156 of user interface 142 to scan the printed document to be stored as the new file. After scanning the printed document, the user is prompted to enter the icon identifier 568, e.g., using keyboard 154. The user is then prompted to connect the new-file icon to map 500, as described above for map 162 of FIGS. 3 and 4. Alternatively, after inputting icon identifier 568 for the new-file icon, the user is prompted to input the icon identifier 568 of the icon 560 to which the new-file icon will be connected, e.g., icon identifier 568₃ (Bonds) of icon 560₃, and controller 120 causes the new-file icon corresponding to the document to be connected to icon 5603 without further user intervention.

To send a data file of map 500 to one or more destination addresses, according to one embodiment of the present invention, the user selects the icon 560 corresponding to the data file, e.g., icon 560_{N}, corresponding to Bank Report. After selecting icon 560_{N}, the user may be prompted to input the destination addresses, e.g., using keyboard 154, to select the destination addresses, e.g., from another map, etc., and digital transmitter 100 will send Bank Report to the destination addresses. Alternatively, selecting icon 560_{N} may cause the user to be prompted to elect to send Bank Report to one or more pre-selected destination addresses associated with icon 560_{N}. For one embodiment, selecting a functional icon 580 connected to icon 560_{N} causes Bank Report to be sent to one or more destination addresses associated with functional icon 580.

### Conclusion

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A display for a digital transmitter, comprising:
a graphical map having a plurality of interconnected icons, wherein a size of each of the icons varies according to the distance of the respective icon from a central region of the display.

2. The display of claim 1, wherein the icons are larger in the central region and smaller near edges of the display.

3. The display of claim 2, wherein the icons in the central region correspond to a current location within the graphical map.

4. The display of claim 1, wherein one or more of the icons is a functional icon that when selected causes the digital transmitter to perform a task.

5. The display of claim 1, wherein one or more of the icons is movable from one location of the graphical map to another location of the graphical map for modifying the graphical map.

6. The display of claim 1, wherein the graphical map is a hierarchical map and the icons correspond to different hierarchical levels.

7. The display of claim 1, wherein the display is touch-sensitive.

8. The display of claim 1, further comprising an indicator for displaying historical information about the map.

9. The display of claim 1, wherein the icons correspond to at least one of a folder of a database, a data file of a database, and a destination address for receiving data from the digital transmitter.

10. The display of claim 1, wherein the graphical map is a hierarchical menu for the digital transmitter and the icons correspond to different hierarchical levels of the menu.

11. A digital transmitter comprising:
a scanner adapted to convert printed material into digital data; and
a user interface having a display;
wherein the display comprises a graphical map having a plurality of interconnected icons; and
wherein a size of each of the icons varies according to the distance of the respective icon from a central region of the display.

12. The digital transmitter of claim 11, wherein the icons are larger in the central region and smaller near edges of the display.

13. The display of claim 12, wherein the icons in the central region correspond to a current location within the graphical map.

14. The digital transmitter of claim 11, wherein one or more of the icons is movable from one location of the graphical map to another location of the graphical map.

15. The digital transmitter of claim 11, wherein the graphical map is a hierarchical map and the icons correspond to different hierarchical levels.

16. The digital transmitter of claim 11, wherein one or more of the icons corresponds to a destination address and selecting the one or more of the icons causes the digital transmitter to send the digital data to the destination address.

17. The digital transmitter of claim 11, wherein one or more of the icons corresponds to a data file that contains the digital data.

18. A method for operating a digital transmitter, the method comprising:
displaying elements of a display of the digital transmitter as interconnected icons of a graphical map; and
varying a size of the icons according to their distance from a central region of the display.

19. The method of claim 18, further comprising when one or more icons correspond to a current location within the graphical map, displaying the one or more icons in the central region and enlarging the one or more icons.

20. The method of claim 19, further comprising when one or more icons no longer correspond to the current location within the graphical map, reducing the size of the one or more icons and removing the one or more icons from the central region.

21. The method of claim 20, wherein removing the one or more icons from the central region comprises moving the one or more icons from the central region toward an edge of the display.

22. The method of claim 18, wherein displaying elements of a display of the digital transmitter as interconnected icons of a graphical map comprises locating the icons at different hierarchical levels of the graphical map.

23. The method of claim 18, further comprising modifying the graphical map by disconnecting one of the icons from one part of the map and connecting that icon to another part of the map.

24. The method of claim 18, further comprising modifying the graphical map by adding a new icon to the map.

25. The method of claim 18, further comprising sending digital data corresponding to printed material scanned into the digital transmitter to one or more destination addresses in response to selecting one of the icons.

26. A computer-usable media containing computer-readable instructions adapted to cause a digital transmitter to perform a method, the method comprising:
displaying elements of a display of the digital transmitter as interconnected icons of a graphical map; and
varying a size of the icons according to their distance from a central region of the display.

27. The computer-usable media of claim 26, wherein the method further comprises when one or more icons correspond to a current location within the graphical map, displaying the one or more icons in the central region and enlarging the one or more icons.

28. The computer-usable media of claim 27, wherein the method further comprises when the one or more icons no longer correspond to the current location within the graphical map, reducing the size of the one or more icons and removing the one or more icons from the central region.

29. The method of claim 28, wherein removing the one or more icons from the central region comprises moving the one or more icons from the central region toward an edge of the display.

30. A digital transmitter comprising:
a scanner adapted to convert printed material into digital data;
a user interface having a display; and
a controller connected to the scanner for receiving the digital data, the controller adapted to transmit the digital data to one or more destination addresses selected by a user of the digital transmitter, the controller further adapted to cause the display to perform a method, the method comprising:
displaying elements of the display as interconnected icons of a graphical map;
varying a size of the icons according to their distance from a central region of the display;
when one or more icons correspond to a current location within the graphical map, displaying the one or more icons in the central region and enlarging the one or more icons; and
when the one or more icons no longer correspond to the current location within the graphical map, reducing the size of the one or more icons and removing the one or more icons from the central region.

31. The digital transmitter of claim 30, wherein, in the method, removing the one or more icons from the central region comprises moving the one or more icons from the central region toward a edge of the display.

32. A display for a digital transmitter comprising:
means for displaying elements of the display as interconnected icons of a graphical map;
means for varying a size of the icons according to their distance from a central region of the display;
means for displaying one or more icons in the central region and enlarging the one or more icons when the one or more icons correspond to a current location within the graphical map; and
means for reducing the size of the one or more icons and removing the one or more icons from the central region when the one or more icons no longer correspond to the current location within the graphical map.
